(19) United States
(12) Patent Application Publication
(10) Pub. No.: US 2025/0207762 A1
(43) Pub. Date: Jun. 26, 2025

(54) Signal device and method for producing a signal device

(71) Applicant: WERMA Holding GmbH + Co. KG, Rietheim-Weilheim (DE)

(72) Inventor: Ronny LAUER, Villingen-Schwenningen (DE)

(21) Appl. No.: 18/986,879

(22) Filed: Dec. 19, 2024

(30) Foreign Application Priority Data
Dec. 22, 2023 (DE) 102023136526.6

(51) Int. Cl. F21V 17/10; F21V 15/01; F21W 111/00

(52) U.S. Cl. CPC F21V 17/101; F21V 15/01; F21W 2111/00

(57) ABSTRACT

A method and a signal device are proposed, having a housing made up of at least two housing elements (2), which are arranged adjacent to one another along a longitudinal axis (A) of the signal device, wherein the housing elements (2) each have at least one housing jacket section, in particular a cylinder housing jacket, and a transverse section (4) extending transversely to the longitudinal axis (A), wherein a separating element (3) extending transversely to the longitudinal axis (A) is attached to at least one of the at least two housing elements (2) as a partition between the at least two housing elements (2) and/or wherein at least one of the at least two transverse sections (4) comprises the separating element (3), which has an improved housing element or segment and/or separating element. This is achieved according to one example in that at least one of the at least two transverse sections (4) has at least one hotmelt adhesive layer (3) for adhesively bonding/connecting/fixing the separating element (3) with this transverse section (4).

### CROSS-REFERENCE TO RELATED APPLICATION

This application claims priority to German Application No. 10 2023 136 526.6, filed Dec. 22, 2023, the content of which is hereby incorporated by reference in its entirety.

### BRIEF DESCRIPTION OF THE DRAWINGS

FIG. 1 shows a perspective representation of a cut-open base element of a signal column according to one example.

FIG. 2 shows a perspective representation of the base element according to FIG. 1.

FIG. 3 shows a schematic representation of production steps of a base/housing element having separating element according to one example.

### DETAILED DESCRIPTION

The present disclosure relates to a signal device, such as a signal column, a signal lamp, or the like.

So-called signal lamps, consisting of a base element and a spherical cap, are known commercially. These housing elements are generally manufactured separately and assembled. In general, the electrical connection elements for an external power supply and, if needed, an external control, are located in the base.

Furthermore, for example, signal columns are known from documents EP 3 174 021 A1 and WO 95/28598, in which the spherical cap is made of multiple housing elements for multiple segments for different signal elements, for example, to combine different color signals or also acoustic signal elements. Such housing elements or segments, which are arranged adjacent to one another along a longitudinal axis of the signal device, have transverse sections and separating elements usually arranged thereon, which are arranged as a partition transversely to the longitudinal axis. The separating elements are used, among other things, for shading the segments from one another and, for example, as a label for identifying the segment.

Signal columns having separately manufactured separating elements connected to the housing elements of segments are commercially known, which are also used for shading the segments from one another and for fastening a label.

The above-mentioned housing elements or segments consist of hard plastic, wherein an O-ring is provided as a seal in the area of the connecting point of the housing elements for sealing off the segments to the outside, for example.

### OBJECT AND ADVANTAGES

In contrast, an object of the present disclosure is to propose an improved housing element or segment and/or separating element.

This object is achieved proceeding from a signal device according to the preamble of claim 1 and a method according to the preamble of claim 8 by the characterizing parts thereof.

Accordingly, a signal device according to one example is distinguished in that at least one of the at least two transverse sections comprises or uses at least one hotmelt adhesive layer for adhesively bonding/connecting/fixing the separating element to this transverse section.

With the aid of this measure, a faster, more automated, and more secure process can advantageously be implemented. This has the result that a particularly cost-effective production process or signal device can be implemented.

In the meaning of the present disclosure, a hotmelt adhesive, also called hot adhesive, hotmelt, or hot glue, is a product which is free of solvents and water and is more or less solid at room temperature. It is in the form of a viscous liquid in the hot or heated state and can be applied in this state to the corresponding adhesive surface. Upon cooling, the hotmelt adhesive typically solidifies reversibly and produces a solid bond. This group of adhesives are thermoplastic polymers, which can be based on various chemical raw materials.

At least the hotmelt adhesive layer is advantageously a plastic. These hotmelt adhesives can be divided, for example, into physically and chemically bonding adhesives. The physically bonding adhesives are thermoplastics, the chemically bonding adhesives form thermoset plastics, i.e. three-dimensional networks. Another type of classification is possible with respect to the solidification mechanism. In this case, the hotmelt adhesives are classified into amorphous polymers, partially crystalline polymers, and high-molecular-weight polymers, wherein the glass temperature is above room temperature in the case of the first two and the glass temperature is below room temperature in the case of the latter.

The most important polymers used for physically bonding hotmelt adhesives are, for example, polyamide resins, saturated polyesters, ethylene-vinyl acetate copolymers (EVA), polyolefins, block copolymers (styrene-butadiene-styrene or styrene-isoprene-styrene), and polyimides. Polyamides, polyesters, and polyimides are used in so-called high-performance hotmelt adhesives, and ethylene vinyl acetate copolymers and polyolefins are used in so-called bulk hotmelt adhesives.

In one special refinement, at least one of the at least two transverse sections is formed as the hotmelt adhesive layer. In this case, separators in the form of additional plastic parts or the like are not necessary.

In an advantageous variant, at least the separating element is formed as the hotmelt adhesive layer. Savings of separate labels can be implemented using this measure, wherein labels are typically always identical for each batch.

At least the separating element and/or the hotmelt adhesive layer is advantageously formed as a film. This can advantageously be adhesively bonded/connected/fixed on/to the respective housing element and/or transverse section.

For example, the film is arranged on a roll or roller or the like and during the production process is unrolled/unwound over the respective housing element and/or transverse section and advantageously heated and applied or pressed on, in particular by means of hot film embossing.

This is printing production by means of a film, the coating or second/additional cover/ply of which is dissolved or detached by pressure and heat from the carrier layer/ply/film and pressed onto the respective surface. This can advantageously also be applied in conjunction with embossing. The hot film embossing can thus also be combined in the printing method with relief embossing or raised embossing. The latter is particularly suitable in the sometimes provided three-dimensional surface of the housing element or transverse section in the area of the hotmelt adhesive bonding. Accordingly, the separating element advantageously comprises at least one hot embossing film.

In one advantageous variant, the separating element and/or the hot embossing film can be inscribed, preferably using a laser. The separating element and/or the hot embossing film can thus implement the function as a nameplate. Automated application of separating elements and/or hot embossing films in the correct location can also be implemented, in particular as nameplates, especially also of relatively small size, which currently represents a great challenge.

In principle, an inscription or other information can be applied, for example, on a separating element, advantageously, inter alia, by machine or in an automated manner. This can be carried out, for example, by means of a print, a pen, or advantageously by means of a laser or the like and can possibly take place specifically for each individual manufactured part. The application of such information is made more difficult on hard plastic, because of which up to this point separately manufactured labels have been used, with corresponding manufacturing and installation expenditure.

In general, a separating element according to one example can be made nontransparent to visible light, in order to effectuate the mutual shading between individual housing elements of the signal device, in particular of segments of a signal column.

In addition, an elastomer can be provided as a seal, for example, a lip seal and/or an O-ring, for example, in a groove provided separately for this purpose of the respective housing element and/or transverse section.

Information applied in the area of the separating element, in particular by inscription or coding, for example, by a QR code or the like, is preferably applied by means of a controllable tool such as a laser. It is thus possible to apply the information during the manufacturing of the separating element without further identifying elements. In particular, the application of individual, part-specific information is simplified by this measure.

For the use of the separating element for the mutual shading of the housing elements, it preferably has a continuous separating surface, which can be interrupted by at least one recess for at least one connecting element for the electrical connection of a signal element arranged in the adjacent housing element. A continuous light-absorbing or light-reflecting surface is advantageous for the shading, wherein for functional reasons the connecting element or elements for the signal elements housed in an adjacent housing element can be led through the separating element. Since this separating surface is generally easily accessible, it is suitable at the same time for easily visible information or inscription.

The connecting elements can close these recesses in the installed state and thus contribute to the shading. The connecting element or elements can be designed in a variety of ways, for example, as a single contact, in particular as a contact spring, or as a printed circuit board protruding through the housing elements.

The separating element can be molded/adhesively bonded/fixed on a housing element to form one piece, which is advantageous in particular in the case of large quantities. However, it can also be connectable to the housing element as a separately manufactured component, due to which, for example, different separating elements are usable with identically shaped housing elements or identical separating elements are usable with differently designed housing elements.

As already mentioned, a signal device according to one example can be a signal column having a multipart spherical cap formed from various segment elements or a signal lamp having a housing made of a one-piece spherical cap and a base element.

The described separating element can thus also be for separating a base from a spherical cap and for separating individual housing elements of a multipart spherical cap made up of multiple segments, for example, of a signal column.

In principle, according to one example, the function of the light separation can advantageously be implemented using the separating element. For example, a (white) hot embossing film for absorbing the light can be applied or “stamped” on the segment/housing element/transverse section.

The so-called upper surface of the segment/housing element or transverse section can also be used or employed/covered as completely as possible/substantially completely. For example, the film or its adhesive layer adheres at all points at which a material is present on the segment/housing element/transverse section, in particular in hot pressing methods.

According to one example, a minimized emission of the light upward can be implemented. The recesses on the segment/housing element or transverse section, i.e. plastic part, are also advantageously not glued over in this case.

In general, an automated application of nameplates of particularly small size can be implemented according to one example. The engraving using laser also particularly enables automated application and individual inscription options. Trackability or so-called “traceability” of the elements can also be produced with the aid of the serial number/QR code or the like, possibly individually. Furthermore, a very high resolution can be implemented by the engraving, which improves the quality. For example, a QR code can be provided for traceability and for storing technical documents of the product, a QR code as a link for an app, and/or a QR code for radio access data, etc.

It has been shown that it is particularly advantageous, for example, to use a method having a thermal transfer film, wherein advantageously this or its corresponding layer/cover/ply can be transferred by a hot embossing method via a stamp onto the surfaces and/or a hot embossing film/thermal transfer tape adheres on the surfaces with “counter material”, in particular on the transverse section or segment, wherein advantageously gaps/recesses or the like are not glued over.

A stamp for the hot embossing can thus advantageously consist of silicone, which is selectable in different hardnesses. The softer the silicone is, the more surface irregularities can be balanced out and deeper levels are also embossed.

Subsequently, the individual inscription advantageously takes place, in particular by means of a laser, in an automation line.

The function as a nameplate can advantageously be implemented according to one example, wherein for the connecting elements, for example, the laser inscription directly on the surface is also possible and/or for/in light and acoustic elements, the lasering is provided, to the greatest extent possible, after the application of the separating element or thermal transfer tape.

In general, for example, the full surface can be utilized and/or an individual inscription or the like can be provided with the aid of the present disclosure upon the integration in the automation process.

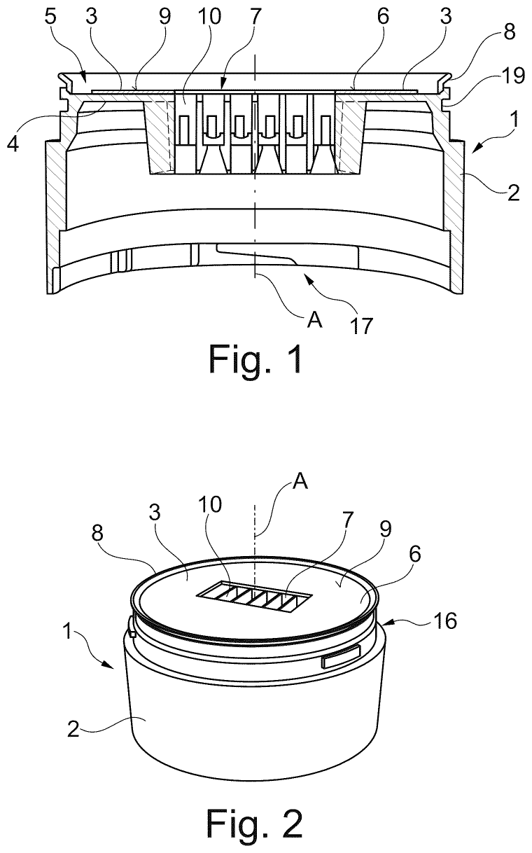

A base element 1 in FIG. 1 comprises a cylinder/base housing 2 having an upper transverse section 4 and a separating element 3. The transverse section 4 is integrally formed with the base housing 2 and forms a cylinder bottom of the base element 1 and a support element for the separating element 3. This means that the separating element 3 is formed as the upper part 5 of the transverse section 4. Accordingly, in the present exemplary embodiment, the transverse section 4 or the lower part 4 is formed from the same hard plastic as the base housing 2, while the upper part 5 or the applied separating element 3 is entirely formed of a different material, in particular a plastic such as a thermoplastic or the like.

The upper part 5 or separating element 3 has a continuous surface 6, which is interrupted, for example, by a recess 7 for contact elements. The surface 6, which is easily visible in each individual housing element 2, 11, can be inscribed or marked or identified in another manner using an actuatable tool such as a laser 22 or the like.

The separating element 3 or upper part 5 is not transparent to visible light, so that the housing elements 11, which are typically arranged adjacent in operation, are shaded in relation to one another.

A lip seal 8, which seals radially on an inner circumference of an adjacently arranged housing element 11 plugged on above it along a longitudinal axis A, is attached to the edge of the transverse section 4 or upper part 5.

FIG. 1 furthermore shows individual receptacles 10 for electrical connections or conductor end sleeves (not shown) of electrical connection cables to be supplied externally and, for example, contact springs (not shown) which can be attached for the electrical connection of signal elements housed in adjacent housing elements 2, 11, for example, on printed circuit boards. These printed circuit boards typically support the signal elements, such as lights or acoustic warning means, for example, lamps, LEDs, piezoelectric buzzers, horns, or the like, in advantageous embodiments.

The housing elements 11 and the base housing 2 are connected to one another via bayonet fittings 16, 17. The lip seal 8 of the respective transverse section 4 of a housing element 11 seals radially in relation to an inner circumference 20 of the closest housing element 11. Other seals such as O-rings or the like can also be used, the overall housing of the signal column consisting of the base housing 2 and the further housing elements 11 is thus advantageously sealed against dust and/or moisture as needed. In addition, the lip seal 8 causes significantly less friction resistance than an O-ring upon rotation of a bayonet fitting 16, 17.

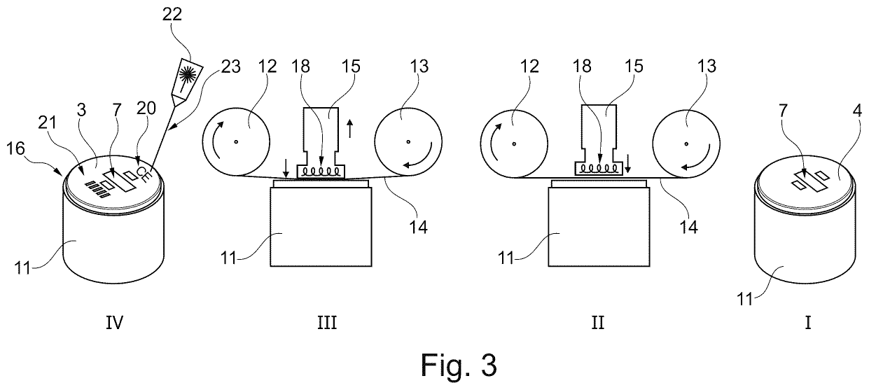

FIG. 3 schematically shows individual production steps for the application or production of the separating element 3. In this exemplary embodiment, the separating element 3 is formed as a hotmelt adhesive layer 3 according to one example.

Alternatively, the transverse section 4 can also be formed as a hotmelt adhesive layer 4 according to one example, wherein in contrast to the variant shown, a film 14 or a stamp 15 is not heated during the production using a heater 18, but rather the transverse section 4 is heated, for example, by means of infrared radiation or a heater 18 and at least superficially initially melted or superficially caused to melt.

In the variant shown according to FIG. 3, for example, in a first step I, the base or housing element 2, 11 is supplied to the hotmelt adhesive bonding or application device, wherein said base or housing element 2, 11 does not yet have a separating element 3 on the transverse section 4 in the meaning of the present disclosure. In a second step II, for example, a two-layer or multilayer film 14 is unrolled from a first roll 13 and rolled up again by a second roll 12, wherein a stamp 15 having integrated heater 18 is arranged in the interval between the rolls 12, 13. This stamp 15 can be vertically adjusted, so that in step III it presses the film 14 onto the element 11 and in this case heats or begins to melt the film 14 at the same time, wherein this stamp 15 is kept at constant temperature to the greatest possible extent.

At least one layer of the film 14 thus detaches and adhesively bonds to the transverse section 4 or its surface. According to one example, the separating element 3 is thus adhesively bonded or formed on the transverse section 4 as a hotmelt adhesive layer 3 according to one example (cf. step IV).

Because the stamp 15 advantageously consists partially or on its lower side of silicone or the like, irregularities of the transverse section 4 can be compensated and moreover the recesses 7 of the transverse section 4 are not covered by the separating element 3 or the film 14, in particular its uppermost layer.

In step IV of FIG. 3, a laser 22 having a laser beam 23 is additionally schematically shown, which subsequently/finally also attaches/applies or embosses an inscription 20 and/or a code 21 for (individual) identification of the element 11 or the separating element 3.

In general, in a special refinement, for example, the film 14 or a special embossing film can run below the embossing stamp, which detaches under (high) pressure and heat from a carrier material of the film 14 and transfers onto the element 2, 11 to be printed. The film 14 advantageously often consists of multiple layers. For example, a separating layer is located on a carrier layer or base layer. This melts when the hot embossing tool 15 or the stamp 15 strikes thereon and exposes the transfer layer(s) lying above it. These in turn possibly comprise an adhesive layer and an optically active layer and together form the separating element 3 according to one example. The adhesive layer, i.e. the hotmelt adhesive, ensures that the optically active layer is bonded/fixed in a smudge-proof and permanent manner with the printed element 2, 11 and forms the separating element 3.

However, variants are also usable, wherein the adhesive layer and the optically active layer, i.e. the separating layer, form a (common) layer of the separating element 3 according to one example. In this case, however, a carrier layer for unrolling/rolling the film 14 is still advantageous in the above-mentioned unrolling technology.

Although the present invention has been described with reference to preferred embodiments, workers skilled in the art will recognize that changes may be made in form and detail without departing from the spirit and scope of the invention.

### LIST OF REFERENCE SIGNS

1 base element
2 base housing
3 separating element
4 transverse section
5 upper part
6 surface
7 recess
8 lip seal
9 inscription surface
10 receptacle
11 housing element
12 roll
13 roll
14 film
15 stamp
16 bayonet fitting
17 bayonet fitting
18 heater
19 groove
20 inscription
21 code
22 laser
23 laser beam
A longitudinal axis

1. A signal device comprising:
a housing comprising at least two housing elements arranged adjacent to one another along a longitudinal axis of the signal device, wherein
each housing element, of the at least two housing elements, has at least one housing jacket section and a transverse section extending transversely to the longitudinal axis,
a separating element extends transversely to the longitudinal axis,
the separating element is attached to at least one housing element, of the at least two housing elements, as a partition between the at least two housing elements and/or at least one of the at least two transverse sections comprises the separating element, and
at least one transverse section, of the at least two transverse sections, has at least one hotmelt adhesive layer for adhesively bonding/connecting/fixing the separating element with the at least one transverse section.

2. The signal device according to claim 1, wherein at least one transverse section, of the at least two transverse sections, is formed as the at least one hotmelt adhesive layer.

3. The signal device according to claim 1, wherein at least the separating element is formed as the at least one hotmelt adhesive layer.

4. The signal device according to claim 1, wherein at least the separating element and/or the at least one hotmelt adhesive layer is formed as a film.

5. The signal device according to claim 1, wherein at least the at least one hotmelt adhesive layer comprises a plastic.

6. The signal device according to claim 1, wherein the separating element comprises at least one hot embossing film.

7. The signal device according to claim 6, wherein the separating element and/or the hot embossing film is inscribed using a laser.

8. A method for producing a housing element of a housing of a signal device, the method comprising:
attaching a separating element, extending transversely to a longitudinal axis, to at least one transverse section of the housing element as a partition between two housing elements, and
using at least one hotmelt adhesive to adhesively bonding/connecting/fixing the separating element to the transverse section.

9. The method according to claim 8, wherein at least the transverse section is formed as a hotmelt adhesive layer.

10. The method according to claim 8, wherein at least the separating element is formed as a hotmelt adhesive layer.

11. The method according to claim 8, wherein a plastic is used as a hotmelt adhesive.

12. The method according to claim 8, wherein at least one hot embossing film is used as a separating element.

13. The method according to claim 8, and further comprising:
after application of the separating element and/or the hot embossing film, inscribing the separating element and/or the hot embossing film using a laser.

14. The method according to claim 8, wherein the inscription comprises a nameplate.

15. The signal device according to claim 1, wherein the at least one housing jacket section comprises a cylinder housing jacket.

16. The signal device according to claim 1, wherein the signal device comprises a signal column.

17. The signal device according to claim 1, wherein the signal device comprises a signal lamp.
